(19) United States
(12) Patent Application Publication
(10) Pub. No.: US 2012/0260811 A1
(43) Pub. Date: Oct. 18, 2012

(54) DEVICE FOR COMPACTING HOLLOW BODIES, IN PARTICULAR BEVERAGE CANS

(76) Inventors: Maik Schulenberg, Bramsche (DE); Johann A. Löning, Oldenburg (DE)

(21) Appl. No.: 13/501,384

(22) PCT Filed: Sep. 30, 2010
(86) PCT No.: PCT/DE10/01156

§ 371 Date: Jun. 25, 2012

(30) Foreign Application Priority Data
Oct. 12, 2009 (DE) 10 2009 049 070.1

(51) Int. Cl. B30B 3/04

(52) U.S. Cl. 100/176

(57) ABSTRACT

A device is disclosed for compacting hollow bodies, in particular beverage cans, having a roller (3) that acts against a counter bearing to form a draw-in gap (23); said roller has an essentially cylindrical body (10) from which draw-in elements (12) project, which run continually in the longitudinal direction of the rollers essentially across the full length of the rollers and are arranged in parallel to one another. The object to be attained by the invention is to provide a compacting device with draw-in elements that, in addition to being effective drawing-in element, provides effective compacting. In an exemplary embodiment, the draw-in elements are formed by undulatory running strips (12) with two lateral flanks (13, 14) and a top surface (15) that connect the two lateral flanks, preferably where the edges formed are sharp.

### RELATED APPLICATIONS

The present application claims priority from PCT International Application No. PCT/DE2010/01156 filed Sep. 30, 2010, which claims priority from German Patent Application No. 10 2009 049 070 filed Oct. 12, 2009, the contents of all of which are incorporated herein by reference.

### TECHNICAL FIELD

The present invention relates to a device for compacting hollow bodies, in particular sheet metal beverage cans.

### BACKGROUND

Devices for compacting hollow bodies are known in various embodiments from prior art. With these devices, a roller often acts against a counter bearing, with a draw-in gap for the hollow bodies to be compacted between said components. Draw-in elements project from the roller in a radial fashion; on the one hand, said draw-in elements are designed to improve the draw-in, and on the other hand, they are designed for compacting the hollow body. In most cases, the counter bearing is another roller. However, the counter bearing can also be a disk-shaped component, for example, which has a planar or convex abutment surface.

Examples of devices for compacting hollow bodies can be found in DE 85 15 290 U1; DE 201 11 752 U1; DE 10 2006 036 145 A1; DE 20 2008 012 248 U1; DE 101 14 686 C1; DE 103 25 368 B4; DE 200 23 690 U1; and DE 10 2006 033 617 A1.

DE 103 25 368 B2 discloses a compacting device that has two oppositely drivable rollers, which are arranged at a distance to one another and developed such that empty containers are cut up and crushed between them. For this purpose, each roller has a plurality of disks arranged successively along the axis of the roller. Some of the disks act as pressure disks, and the other disks act as cutting disks. Furthermore, the rollers are arranged such that the disks of the one roller engage in the spaces between the disks of the other roller. With an opposite rotating motion of the rollers, an empty container is pulled into the clearance of the rollers and crushed and cut up by the many pressure and cutting disks. This in particular also allows the compacting of empty, closed containers without having to perforate them first. The draw-in elements of these rollers are formed by the teeth of the cutting disks, which are in the shape of hooks in the direction of the circumference of the rollers.

A compacting device according to DE 85 15 290 U1 also has a pair of rollers, driven in opposite directions, with pin elements projecting in a radial fashion from the body of the rollers as draw-in elements.

DE 200 23 690 U1 describes a device of this class for compacting empty beverage containers. That device has an essentially funnel-shaped tapering conveyer path into which the beverage containers are fed and where they are successively compacted under the action of feed and crushing devices that laterally delimit the feed path. The means for conveying and crushing the beverage containers are comprised of rollers driven by axial cylinder engines. These rollers have, as draw-in elements, a plurality of cutter-shaped elevations distributed on their circumference, which are aligned in parallel relative to one another and run across essentially the entire length of the rollers. Instead of said cutter-like elevations, the rollers also can have pins or spikes that project from their body.

### SUMMARY

The device disclosed herein advantageously provides a device for compacting that is equipped with draw-in elements that, in addition to being an effective drawing-in elements, are also effective compacting elements.

A system is disclosed for compacting hollow bodies comprising a roller and a counter-bearing element, which may be a second and possibly essentially identical roller, positioned with a gap between the roller and counter-bearing element. The gap is formed between the outer diameters of the first roller and the counter-bearing element. The roller may have a cylindrically-shaped body with projecting draw-in elements which run continually in a longitudinal direction of the roller along the body of the roller and are arranged in parallel with one another, wherein the draw-in elements form undulatory strips. The strips of the system may be zig-zag shaped, and the strips may have two flanks that diverge outward and end in a top surface. The top surface of the strips may be essentially planar.

Surprisingly, it was found that devices where the draw-in elements are formed by strips that deviate from a straight course, i.e., which run in an undulatory fashion, very effectively draw the hollow bodies to be compressed into the draw-in gap between the roller and its counter bearing. An additional result is that the hollow bodies leaving the device in accordance with the invention are strongly compacted.

Draw-in elements formed by strips running in a zigzag fashion proved in particular effective.

The roller of a device in accordance with this disclosure acts against a counter bearing. Said counter bearing can be a planar or convex abutment surface of a disk-shaped component, for example. However, the counter bearing is preferably a second roller that is aligned parallel to the first roller, which is furthermore preferably identical to the first roller.

It is to be understood that both the foregoing description and the following description are exemplary and explanatory only and are not restrictive of the invention, as claimed.

### BRIEF DESCRIPTION OF THE DRAWINGS

The invention is explained in greater detail by means of the exemplary embodiments shown in the following drawings. The drawings show:

FIG. 1 is a schematic lateral view of an exemplary embodiment in accordance with the disclosure;

FIG. 2 is a top view of the exemplary embodiment shown in FIG. 1;

FIG. 3 is a perspective view of an end area of the rollers in accordance with the disclosure; and

FIG. 4 is a lateral view of the rollers.

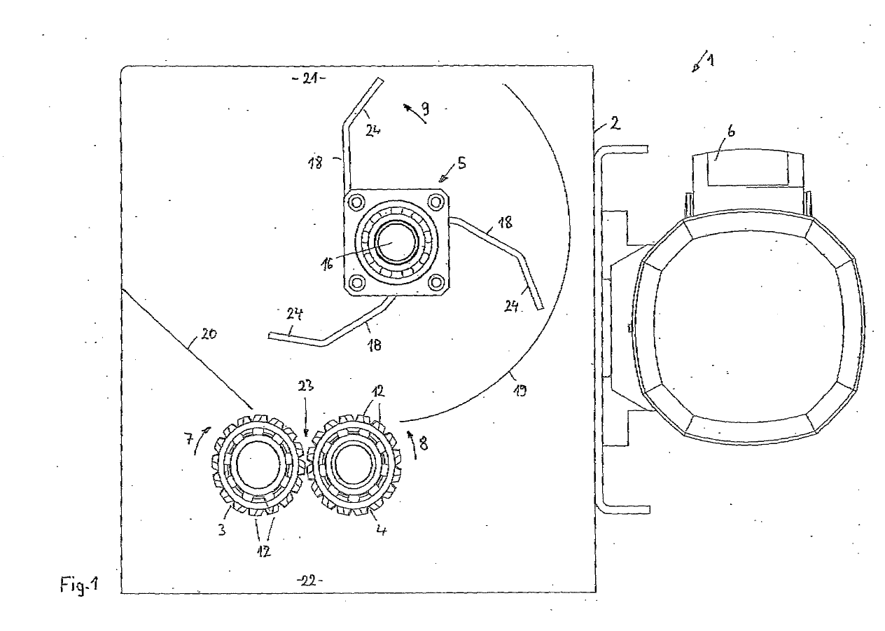

### DETAILED DESCRIPTION

Reference will now be made in detail to the present exemplary embodiments consistent with the disclosure, examples of which are illustrated in the accompanying drawings. Wherever convenient, the same reference numbers will be used throughout the drawings to refer to the same or like parts.

The exemplary device 1 shown in the drawings drawing is intended for compacting sheet metal beverage cans. It has a housing 2, which accommodates two rollers 3 and 4 arranged in parallel, as well as a feed impeller 5. An electromotor 6 is arranged on the outside of the housing 2, which drives the two rollers 3 and 4, via toothed belts and drive chains [not shown], in opposite directions in relation to each other, i.e., in the directions of the arrows 7 and 8. Electromotor 6 also drives the feed impeller 5 in the direction of the arrow 9, i.e., counter-clockwise. A draw-in gap 23 exists between the two rollers 3 and 4.

The rollers 3, 4 have a cylindrical body 10, with bearing and journal pins projecting axially from both ends of said body. Furthermore, a plurality of strips 12 aligned in parallel project in a radial fashion from the body 10 of the rollers 3, 4. The strips 12 have a zigzag form and run in the longitudinal direction of the rollers 3, 4 over their entire length.

As an example, the rollers 3, 4 may be comprised of metal and produced with machining. In that production process, first a full cylinder with a diameter d is turned (see FIG. 4), and then the bearing and driving journals are turned on both sides. The strips 12 are milled from the full cylinder that was turned earlier. At this point, it should be mentioned that the draw-in gap 23 is formed between rollers 3 and 4, i.e., the strips 12 of the two rollers 3 and 4 do not mesh. In the embodiment as shown, the draw-in gap 23 is 1.5 mm; the diameter d of the rollers 3 and 4 is 63 mm.

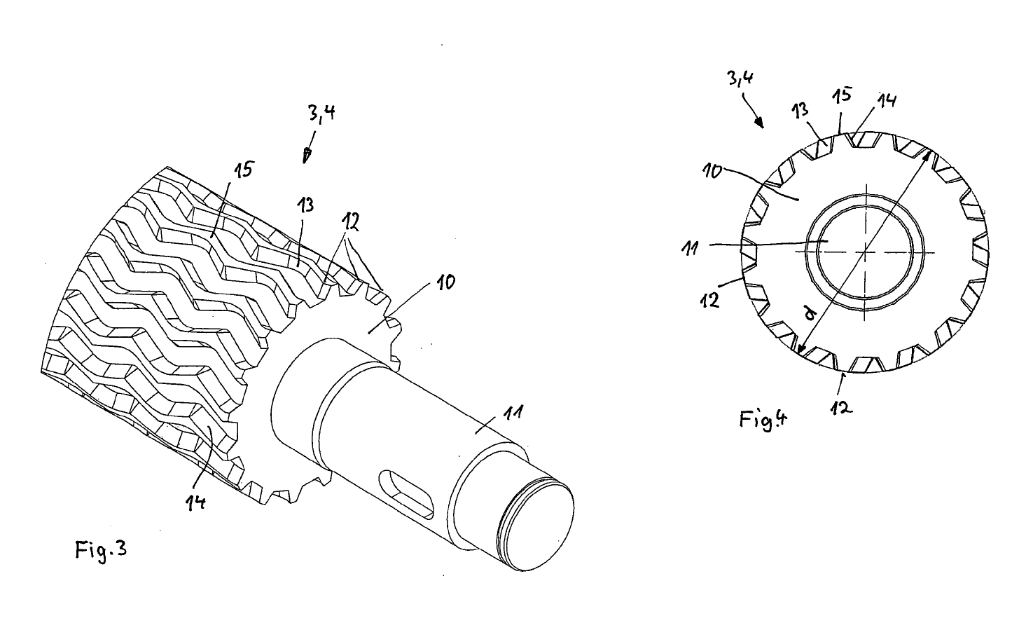

FIGS. 3 and 4 show that the strips 12 of the exemplary embodiment shown have the form of a symmetrical trapezoid, i.e., the two side flanks 13 and 14 of each strip 12 have the same inclination angle and then taper outward, where they end in a top surface 15, which is on the diameter d and is therefore essentially planar because it runs very little in the direction of the circumference; the transitions from the side flanks 13 and 14 to the head surface 15 have sharp edges. The strips 12 are, for example, evenly distributed on the circumference of the rollers 3 and 4. After the rollers 3 and 4 have been machined, they are, preferably, then surface hardened.

The feed impeller 5 has as a central shaft 16 and is rotatably supported on both sides of the housing 2 via said shaft. Flanges 17 are arranged at the end areas of the shaft 16 to rotate therewith, and three blades 18 are fastened in a respective distance of approx. 120° on said flanges. Said blades 18 preferably consist of folded sheet metal. The feed impeller 5 is designed on the one hand to feed the beverage cans to be compacted to the rollers 3 and 4 and, in cooperation with a return panel 19, for returning beverage cans not initially compacted to the rollers 3 and 4, which will be described in greater detail below. The return panel 19 is arranged concentrically to the shaft 16 of the feed impeller 5 and has a slightly larger diameter than the diameter of the blades 18. It runs from an area adjacent to the roller 4 up to an area above the shaft 16 of the feed impeller 5.

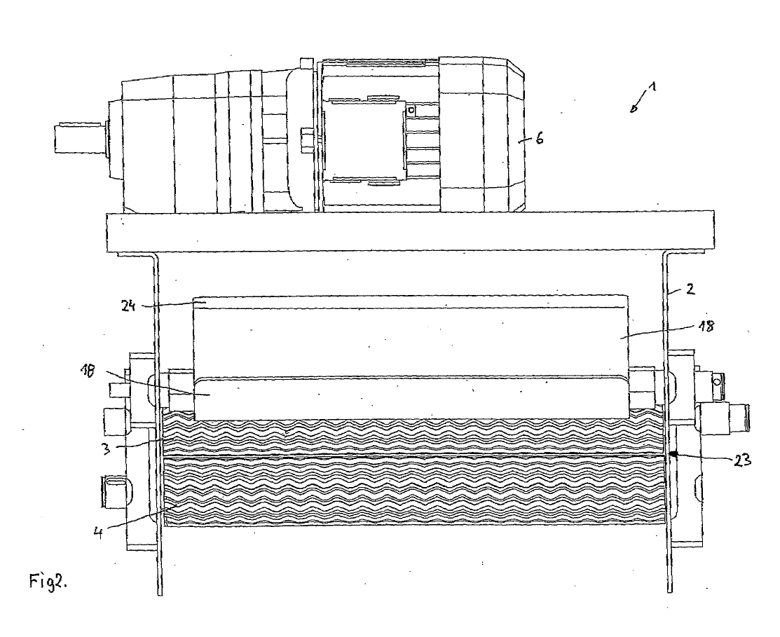

Also arranged in the housing is a feed panel 20, which is attached to the housing 2 on one edge and runs angularly downward toward roller 3. The return panel 19 and the feed panel 20 run essentially over the entire length of the rollers 3 and 4. For clarity, the feed panel 20, the return panel 19, and one blade 18 of the feed impeller 5 have been omitted in FIG. 2.

The housing 2 has on its upper end an input opening 21 and on its lower end an output opening 22.

The method of operation of the exemplary device 1 described above is explained in greater detail in the following.

Beverage cans placed into the device 1 via the input opening 21 travel under the effect of gravity via the feed panel 20 into the area of the two rollers 3 and 4. Because said rollers move in opposite directions from one another, i.e., in the direction of the arrows 7 and/or 8, the beverage cans are drawn into the draw-in gap 23 formed between the two rollers 3 and 4. Said draw-in is supported by the feed impeller 5. The ends 24 of the blades 18 are angled such that they exert pressure on the beverage cans in the area of the rollers 3, 4, which is directed into the direction of the draw-in gap 23. The drawn-in beverage cans are flattened in the draw-in gap 23 and at the same time, because of the sharp-edged transitions between the side flanks 13, 14 and the top surfaces 15 of the strips 12, they are cut so that deposit logos or similar safety identifiers are destroyed to prevent any misuse.

The beverage cans that were flattened between the rollers 3, 4 drop down through the output opening 22 into a collection container (not shown). Any beverage cans not drawn in between the rollers 3 and 4 during the first run are captured by the blades 18 of the feed impeller 5 and guided along the return panel 19 so that they finally reach the area of the rollers 3 and 4 again via the feed panel 20.

Other embodiments of the disclosure will be apparent to those skilled in the art from consideration of the specification and practice of the disclosure disclosed herein. It is intended that the specification and examples be considered as exemplary only, with a true scope and spirit of the disclosure being indicated by the following claims.

1.-8. (canceled)

9. A system for compacting hollow bodies, the system comprising:
a roller and a counter-bearing element positioned with a gap between the roller and counter-bearing element, the roller having a cylindrically-shaped body with projecting draw-in elements which run continually in a longitudinal direction of the roller along the body of the roller and are arranged in parallel with one another, wherein the draw-in elements form undulatory strips.

10. The system of claim 9 wherein the strips are zig-zag shaped.

11. The system of claim 9 wherein the counter-bearing element is a second roller positioned parallel to the first roller.

12. The system of claim 10 wherein the counter-bearing element is a second roller positioned parallel to the first roller.

13. The system of claim 11 wherein the second roller is essentially identical to the first roller.

14. The system of claim 12 wherein the second roller is essentially identical to the first roller.

15. The system of claim 11 wherein the gap is formed between the outer diameters of the first and second rollers.

16. The system of claim 12 wherein the gap is formed between the outer diameters of the first and second rollers.

17. The system of claim 13 wherein the gap is formed between the outer diameters of the first and second rollers.

18. The system of claim 14 wherein the gap is formed between the outer diameters of the first and second rollers.

19. The system of claim 9 wherein the strips have two flanks that diverge outward and end in a top surface.

20. The system of claim 10 wherein the strips have two flanks that diverge outward and end in a top surface.

21. The system of claim 11 wherein the strips have two flanks that diverge outward and end in a top surface.

22. The system of claim 12 wherein the strips have two flanks that diverge outward and end in a top surface.

23. The system of claim 13 wherein the strips have two flanks that diverge outward and end in a top surface.

24. The system of claim 14 wherein the strips have two flanks that diverge outward and end in a top surface.

25. The system of claim 15 wherein the strips have two flanks that diverge outward and end in a top surface.

26. The system of claim 16 wherein the strips have two flanks that diverge outward and end in a top surface.

27. The system of claim 17 wherein the strips have two flanks that diverge outward and end in a top surface.

28. The system of claim 18 wherein the strips have two flanks that diverge outward and end in a top surface.

29. The system of claim 19 wherein the top surface is essentially planar.

30. The system of claim 20 wherein the top surface is essentially planar.

31. The system of claim 21 wherein the top surface is essentially planar.

32. The system of claim 22 wherein the top surface is essentially planar.

33. The system of claim 23 wherein the top surface is essentially planar.

34. The system of claim 24 wherein the top surface is essentially planar.

35. The system of claim 25 wherein the top surface is essentially planar.

36. The system of claim 26 wherein the top surface is essentially planar.

37. The system of claim 27 wherein the top surface is essentially planar.

38. The system of claim 28 wherein the top surface is essentially planar.

39. The system of claim 9 wherein the strips and the body of the roller comprise an integrated unit.

40. The system of claim 10 wherein the strips and the body of the roller comprise an integrated unit.

41. The system of claim 11 wherein the strips and the body of the roller comprise an integrated unit.

42. The system of claim 12 wherein the strips and the body of the roller comprise an integrated unit.

43. The system of claim 13 wherein the strips and the body of the roller comprise an integrated unit.

44. The system of claim 14 wherein the strips and the body of the roller comprise an integrated unit.

45. The system of claim 15 wherein the strips and the body of the roller comprise an integrated unit.

46. The system of claim 16 wherein the strips and the body of the roller comprise an integrated unit.

47. The system of claim 17 wherein the strips and the body of the roller comprise an integrated unit.

48. The system of claim 18 wherein the strips and the body of the roller comprise an integrated unit.

49. The system of claim 19 wherein the strips and the body of the roller comprise an integrated unit.

50. The system of claim 20 wherein the strips and the body of the roller comprise an integrated unit.

51. The system of claim 21 wherein the strips and the body of the roller comprise an integrated unit.

52. The system of claim 22 wherein the strips and the body of the roller comprise an integrated unit.

53. The system of claim 23 wherein the strips and the body of the roller comprise an integrated unit.

54. The system of claim 24 wherein the strips and the body of the roller comprise an integrated unit.

55. The system of claim 25 wherein the strips and the body of the roller comprise an integrated unit.

56. The system of claim 26 wherein the strips and the body of the roller comprise an integrated unit.

57. The system of claim 27 wherein the strips and the body of the roller comprise an integrated unit.

58. The system of claim 28 wherein the strips and the body of the roller comprise an integrated unit.

59. The system of claim 29 wherein the strips and the body of the roller comprise an integrated unit.

60. The system of claim 30 wherein the strips and the body of the roller comprise an integrated unit.

61. The system of claim 31 wherein the strips and the body of the roller comprise an integrated unit.

62. The system of claim 32 wherein the strips and the body of the roller comprise an integrated unit.

63. The system of claim 33 wherein the strips and the body of the roller comprise an integrated unit.

64. The system of claim 34 wherein the strips and the body of the roller comprise an integrated unit.

65. The system of claim 35 wherein the strips and the body of the roller comprise an integrated unit.

66. The system of claim 36 wherein the strips and the body of the roller comprise an integrated unit.

67. The system of claim 37 wherein the strips and the body of the roller comprise an integrated unit.

68. The system of claim 38 wherein the strips and the body of the roller comprise an integrated unit.
